(19) United States
(12) Patent Application Publication
(10) Pub. No.: US 2009/0317434 A1
(43) Pub. Date: Dec. 24, 2009

(54) Preparation method for antibacterial nanocomposite fiber materials containing organic intermediates or free-radical scavengers

(76) Inventors: Te-Hsing Wu, Taoyuan County (TW); Nini-Chen Tsai, Taoyuan County (TW); Lie-Hang Shen, Taoyuan County (TW); Bin Lin, Taoyuan County (TW); Chia-Chieh Chen, Taoyuan County (TW); Wuu-Jyh Lin, Taoyuan County (TW)

Correspondence Address: MICHAEL LIN, 5F 79 Roosevelt Rd. Sec. 2, TAIPEI, 106, TW

(21) Appl. No.: 12/144,667

(22) Filed: Jun. 24, 2008

(51) Int. Cl. A01N 25/08; A01N 59/16; A01P 1/00

(52) U.S. Cl. 424/409; 424/618

(57) ABSTRACT

The invention relates to a novel preparation method for antibacterial nano metal composite fiber materials containing organic intermediate or free radical scavengers. The technology for the invention mainly uses γ-ray radiation to a solution mixture containing PAA (polyacrylic acid intermediate) or IPA (Isopropyl alcohol free radical scavenger) and silver nitrate solution to induce crosslinking or grafting on Nylon or PET fiber surface and produce nanocomposite fiber products with excellent antibacterial ability. The main reaction mechanism is through PAA or IPA as additives to assist silver particles in adhering firmly onto Nylon or PET fiber surface. With good thermal stability and chemical stability silver is considered as an excellent inorganic antibacterial agent. It can easily react with enzyme-protein molecules in bacteria and achieve sterilization effect by destructing cell surface and killing the bacteria. The antibacterial testing report indicates Nylon and PET fibers containing nano silver have excellent antibacterial ability. The invented product can be used for functional textiles for medical applications, personal products and manufacturing environment.

### BACKGROUND OF THE INVENTION

1. Field of the Invention

The invention relates to a novel preparation method for antibacterial nano metal composite fiber materials containing organic intermediate or free radical scavengers. Especially it refers to using high-energy radiation to modify Nylon or PET fibers for reacting with mixture solutions of organic intermediates, free-radical scavengers and nano metals, and producing antibacterial nanocomposite fiber materials.

2. Description of the Prior Art

Located in a subtropical area which climate is humid and hot, Taiwan tends to become a place as habitat for bacteria. The odor from towels, underwear or socks etc. in everyday life comes from the ammonia produced after bacteria decompose the amino acids in human sweat as well as the dead bacteria. Therefore, inhibiting bacterial growth can prevent odor. Aseptic condition can minimize the source of odor and prevent odor, and also prevent fibers from aging and discoloring by bacteria. In our living environment there are many harmful bacteria to threaten our health. In view of the fact that it is common for infants to get dermatitis, for young people to get eczema, for patients to get bedsores and there exist many diseases from nosocomial infection, effective control of bacterial growth is the essential solution. Thus, antibacterial and odor-proof textiles become daily necessities. When people start emphasizing hygiene and health care, the demand of antibacterial and odor-proof textiles is certainly increasing. Life quality will improve as well. Things like medical sponges, surgical clothing, bed pads, bed sheets, and bandages that have direct contact with human body or others in daily life like masks, socks, towels, blankets etc. tend to have bacteria growth, and therefore they all need antibacterial fibers to effectively prevent bacterial growth and odor.

Usually antibacterial nanofibers use nano metals as antibacterial additives, which have good thermal stability and therefore can be added to fiber solutions that after fiber spinning will produce the antibacterial fibers. However, because nano particles are very small and have high surface activities, they are susceptible to high temperature in the manufacturing process and therefore tend to form agglomerates that are difficult to interact with fibers. Thus, it is necessary to develop an effective technology to simplify the process so that in the textile backend process antibacterial inorganic nano powders can be stably adhered to textile fibers.

Since 1960, radiation has been widely used to modify polymers through reactions like grafting and crosslinking to produce copolymers. Since high-energy radiation can excite matters to higher energy state, generating free radicals and peroxides to induce polymer grafting and crosslinking reactions. Radiation grafting refers to a method allowing polymer fibers exposed to radiation and capable to combine with other polymers, with the advantage of process simplicity and great potentials to fiber industry. Presently there are examples domestically to use radiation processing to bridge functional additives to fiber materials to produce durable high-performance textiles. Besides, Nuclear Research Institute and Tatung University collaborated on using Co-60 and UV radiation to modify Poly(N-isopropyl acrylamide) (NIPAAm) and gelatin to graft them onto nonwovens by copolymerization and produce trilayer wound patches. They have obtained a Taiwan patent. In addition, Liang Haw Technology Co. also had good accomplishment by using electron beam radiation technology for plastic foams and electronic materials. It was also reported that γ-radiation was used to radiate acrylic acid (AAC), isopropyl acrylamide and chitosam, so they could graft onto nonwovens and produce multifunctional wound patches. This invention further uses radiation modification to prepare antibacterial nanocomposite fibers in a simplified process that uses domestically produced Nylon and PET fibers as substrates.

The antibacterial agents in common antibacterial textile products are organic antibacterial agents, inorganic antibacterial agents, natural antibacterial agents and polymer antibacterial agents etc. Usually organic antibacterial agents do not have durability, high-temperature resistance and photo-aging resistance. They tend to make bacteria develop drug resistance. Most of their decomposition products are toxic and some monomers are carcinogenic. Inorganic antibacterial agents are contact type and inherently antibacterial. They have durability, acid and base resistance, washing proof and non-aging property. They also do not make bacteria produce drug resistance. The compositions and carriers for inorganic antibacterial agents are least toxic. So they are safe to human body and environments and have advantages in good stability and long lasting antibacterial effect. Therefore, inorganic antibacterial agents have been widely used for functional fiber products. Inorganic silver has excellent antibacterial property, but its cost is high. By using nano technology, its antibacterial property can be increased and the usage of silver can be significantly reduced. Block silver has small specific surface area and poor dispersibility and its antibacterial effect can be enhanced by nano technology. Usually it is to use block silver directly for preparing nano silver, or deposition or impregnation or photochemical deposition via physical adsorption to porous materials. The invention also includes organic intermediates and nano silver antibacterial agents as the main reaction agents for antibacterial fiber products.

Usually fiber products are light, uniform and useful. The metal powders in antibacterial materials need to be very small. With advancement in nano technology, several powder technologies can reduce particle size to nanometer level. Besides, nano particles are very different from common powder particles in their properties. The researches in the past addition of nano particles can greatly enhance the inherent material properties and develop different functions. Therefore the invention uses radiation modification technology to combine nano silver antibacterial agents, organic intermediates or free radical scavengers with polymer fibers to produce light, thin and durable antibacterial fiber products.

### SUMMARY OF THE INVENTION

The main point for the invention is to use nano silver antibacterial agents as reactants and radiation modification to fix them on Nylon or PET fiber surface to synthesize antibacterial fiber products.

Radiation grafting technology uses high-energy radiation to irradiate fiber materials and enable them to combine with functional polymers. The process is simple and environmental friendly. Thus, the invention has developed a novel radiation modification technology for the fiber back-end process that allows nano silver powders with organic intermediates or free radical scavengers to be firmly grafted to fiber products.

The main objective for the invention is to use nano silver as antibacterial agents and additional PAA intermediate or IPA free radical scavenger to assist their bonding to fiber substrates, and also use radiation for nano silver particles to adhere or deposit onto Nylon or PET fiber materials. The obtained products are tested and verified by SEM, ICP (Inductively Coupled Plasma), EA (element analysis), XPS, XRD (X ray diffraction) and also tested for antibacterial effect to find out they have over 99.5% sterilization effect on Staphylococcus aureus. Their antibacterial effect is proved by the analytical and testing results.

### DETAILED DESCRIPTION OF THE PREFERRED EMBODIMENT

The radiation technology in the invention is a process to use cobalt-60 γ-ray (or electron beam) (as shown in FIG. 1) and consists of the following steps:

1. Post radiation process

(a) cut Nylon and PET fiber substrate in a suitable size (≧10 cm×10 cm);

(b) mix and agitate evenly the mixture of silver nitrate solution and PAA or IPA solution; impregnate Nylon and PET fiber materials into the solution for more than two hours;

(c) the above fiber materials are subject to pressing and sucking by a nip roll to remove the extra mixture solution from the above;

(d) put Nylon and PET fiber semi-products to a sealed plastic bag and irradiate them for modification.

### 1. Embodiment 1

Take Nylon and PET fiber materials of the same size (≧10 cm×10 cm). Put them into a mixture solution containing more than 3.5 g PAA (organic intermediate) and higher than 0.1M AgNO₃ solutions for more than two hours. Remove extra solution by pressing and sucking. Irradiate the treated Nylon and PET fibers with less than 80 kGy dosage to reduce silver particles and make them adhere to the fibers. The SEM picture in FIG. 2 shows the Nylon fibers after radiation. From FIG. 2(a) it can be found than Nylon fiber surface is very smooth and does not have apparent deposition of silver particles. To further investigate fiber surface, the magnification is increased to 10,000 times. Thus, it can be found on the fiber surface that there seems to have a layer, which could be formed by PAA grafted or crosslinked to Nylon fiber surface after radiation. For silver content on Nylon fibers, ICP measurement result indicates it is only 0.83 wt %. FIG. 3 is the SEM picture for PET fibers after radiation. It can be found from FIG. 3(a) that the fiber surface clearly has a layer, which is formed by PAA radiation grafting to PET fiber surface. The magnification is further increased to 5000 times. The picture shows many protruding particle-like objects on fiber surface. They could be reduced silver particles in the PAA layer.

From PAA characteristics and past literatures, it can be known that PAA is usually used as gel stabilizer and protective agent from agglomeration for nano silver particles. On the other hand, PAA can combine with fibers through radiation grafting or crosslinking. Therefore, the invention first selects common polymers as the intermediates for radiation grafting or crosslinking for silver to improve the silver content.

TABLE 1
Effect of PAA on Fiber Silver Content after Radiation Grafting

| | Before rinse | After rinse |
|---|---|---|
| Nylon | | |
| 0 PAA* | 15.33 wt % | 2.15 wt % |
| 1/1 PAA* | 13.43 wt % | 0.83 wt % |
| PET | | |
| 0 PAA | 11.57 wt % | 1.08 wt % |
| 1/1 PAA | 15.61 wt % | 3.04 wt % |

*0 PAA is for pure silver nitrate; 1/1 PAA is for added PAA proportional to the silver content on silver nitrate solution

Table 1 shows the effect of PAA on fiber silver content after radiation grafting. For Nylon fibers, adding PAA actually decreases silver content after radiation grafting, from 2.15 wt % to 0.83 wt %. For PET fibers, adding PAA increases silver content after radiation grafting, from 1.08 wt % to 3.04 wt %.

### 2. Embodiment 2

Usually aqueous solutions generate many products containing free radicals other than hydrated electrons after γ-ray radiation. To prevent unnecessary reactions for free radicals with silver ions or fibers, the invention uses free radical scavenger IPA in silver nitrate solution and impregnate Nylon and PET fibers in this solution for more than two hours. After that, the fibers are subject to pressing and sucking to remove extra solution. The treated Nylon and PET fibers are exposed to Co-60 radiation of less than 80 kGy dosage to reduce the silver particles. FIG. 4 is the XRD spectrum for silver nitrate impregnated Nylon fibers after Co-60 radiation. When IPA content increases from 0 vol % to 30 vol %, the XRD spectrum does not show clear Ag(111) peak. FIG. 5 is the XRD spectrum for silver nitrate impregnated PET fibers after Co-60 radiation. It can be found from the figure that when IPA usage is increased from 0 vol % to 20 vol %, the Ag(111) peak on XRD spectrum is not clear, but when IPA content is 30 vol %, a weak Ag(111) peak is shown at 2θ=38° on XRD spectrum.

FIG. 6 and FIG. 7 show the relationship between IPA usage and the silver content on Nylon fibers and PET fibers respectively. The Nylon and PET fibers have been rinsed by deionized water for a while. It is found from the figure that although the silver content on Nylon fibers varies slightly with IPA usage, the silver content is always around 2 wt %. For PET fibers, the silver content is slightly affected by IPA usage. When IPA is between 0 vol % and 20 vol %, silver content does not vary much; when IPA is increased 30 vol %, silver content also increases to 1.37 wt %.

FIG. 8 shows the SEM pictures for Nylon fibers impregnated in 0.5M silver nitrate solutions containing different ratio of IPA. When 10 vol % or 20 vol % IPA is added, it is found that Nylon fiber surface after radiation has a deposition layer of closely packed nano silver particles (FIGS. 8(a)˜(d)). Under 10 vol % and 20 vol % IPA effect, the silver content on Nylon fiber surface is measured by ICP to be 1.60 wt % and 1.96 wt % respectively. Besides, it is also found that when IPA is 30 vol %, the layer of closely packed nano silver particles is not found on fiber surface. The fibers in FIGS. 8(e) and (f) have 1.82 wt % silver content measured by ICP.

FIG. 9 shows the SEM pictures for PET fibers impregnated in 0.5M silver nitrate solutions containing different ratio of IPA. When 10 vol % or 20 vol % IPA is added, it is found that PET fiber surface after radiation has a deposition layer of more closely packed nano silver particles than that for Nylon (as shown in FIG. 9). If the magnification is increased to 10000 times, it can be found that nano silver particles form an uniform silver layer that does not have voids except surface cavities, as shown in FIG. 9(b). When IPA is 10 vol % and 20 vol %, the silver content on PET fiber surface is measured by ICP to be 0.72 wt % and 0.79 wt % respectively. When 30 vol % IPA is used, silver particles form a thicker deposition layer on fiber surface as shown in FIG. 9(e), (f). The silver content on PET fiber is 1.37 wt %.

### 3. Antibacterial Ability Test

To test the antibacterial ability for the textile products from the invention, Staphylococcus aureus is selected as the bacteria. US standard AATCC 100-1999 measurement is used for the testing. The antibacterial fibers to be tested are through direct radiation and have higher silver content than those from other preparation methods.

TABLE 2
Antibacterial Testing Report by Taiwan Textile Research Institute
(Antibacterial Nylon Fibers from the invention)

| | | Testing Result (Nylon) | | | | |
|---|---|---|---|---|---|---|
| | | wt % IPA content in AgNO₃ | | | | |
| Testing Item | | 0 wt % | 10 wt % | 20 wt % | 30 wt % | Testing Method |
| Staphylococcus | B* | 1.27E+5 | 1.27E+5 | 1.27E+5 | 1.27E+5 | AATCC |
| aureus | A* | 1.8E+3 | 1.66E+5 | 2.67E+4 | <100 | 100-1999 |
| | R (%)* | 98.58 | <0 | 78.89 | >99.92 | |

Table 2 is the antibacterial testing report for the Nylon fibers by radiation reduction method of the invention. Except the fiber product with 10 wt % IPA, all other Nylon fibers with silver have antibacterial effect. It is thought to be due to experiment error for the fiber with 10 wt % IPA not to show antibacterial effect. The fibers with 30 wt % IPA have the antibacterial ability as high as 99.92%.

TABLE 3
Antibacterial Testing Report by Taiwan Textile Research Institute
(Antibacterial PET Fibers from the invention)

| | | Testing Result (PET) | | | | |
|---|---|---|---|---|---|---|
| | | wt % IPA content in AgNO₃ | | | | |
| Testing Item | | 0 wt % | 10 wt % | 20 wt % | 30 wt % | Testing Method |
| Staphylococcus | B* | 1.27E+5 | 1.27E+5 | 1.27E+5 | 1.27E+5 | AATCC |
| aureus | A* | 333 | <100 | 100 | <100 | 100-1999 |
| | R (%)* | 99.74 | >99.92 | 99.92 | >99.92 | |

Table 3 is the antibacterial testing report for the PET fibers by radiation reduction method of the invention. PET fibers containing silver particles have significant antibacterial ability, as high as 99%. The testing report also indicates both Nylon and PET fibers with silver have antibacterial ability and PET is more prominent.

### BRIEF DESCRIPTION OF THE DRAWINGS

FIG. 1 is an illustration for Co-60 γ-ray (or electron beam) to irradiate fiber materials.

FIG. 2 is the SEM pictures for antibacterial Nylon fibers under (a) 2000 times magnification (b) 10000 times magnification and the experiment condition: 0.5 liter 0.5M silver nitrate solution added with 13.5 g PAA, <80 kGy dosage of radiation to Nylon fibers.

FIG. 3 is the SEM pictures for antibacterial PET fibers under (a) 500 times magnification (b) 5000 times magnification and the experiment condition: 0.5 liter 0.5M silver nitrate solution added with 13.5 g PAA, <80 kGy dosage of radiation to PET fibers.

FIG. 4 is the XRD spectra for (a) Nylon fibers, (b) impregnated with silver nitrate, (c) impregnated with silver nitrate containing 10 vol % IPA, (d) impregnated with silver nitrate containing 20 vol % IPA, (e) impregnated with silver nitrate containing 30 vol % IPA.

FIG. 5 is the XRD spectra for (a) PET fibers, (b) impregnated with silver nitrate, (c) impregnated with silver nitrate containing 10 vol % IPA, (d) impregnated with silver nitrate containing 20 vol % IPA, (e) impregnated with silver nitrate containing 30 vol % IPA.

FIG. 6 shows the silver content for Nylon fibers impregnated with silver nitrate containing IPA.

FIG. 7 shows the silver content for PET fibers impregnated with silver nitrate containing IPA.

FIG. 8 is the post radiation SEM pictures for antibacterial Nylon fibers under (a) 5000 times magnification, (b) 10000 times magnification and impregnation solution containing 10 vol % IPA; (c) 5000 times magnification, (d) 10000 times magnification and impregnation solution containing 20 vol % IPA; (e) 2000 times magnification, (f) 10000 times magnification and impregnation solution containing 30 vol % IPA.

FIG. 9 is the post radiation SEM pictures for antibacterial PET fibers under (a) 2000 times magnification, (b) 20000 times magnification and impregnation solution containing 10 vol % IPA; (c) 5000 times magnification, (d) 20000 times magnification and impregnation solution containing 20 vol % IPA; (e) 1000 times magnification, (f) 20000 times magnification and impregnation solution containing 30 vol % IPA.

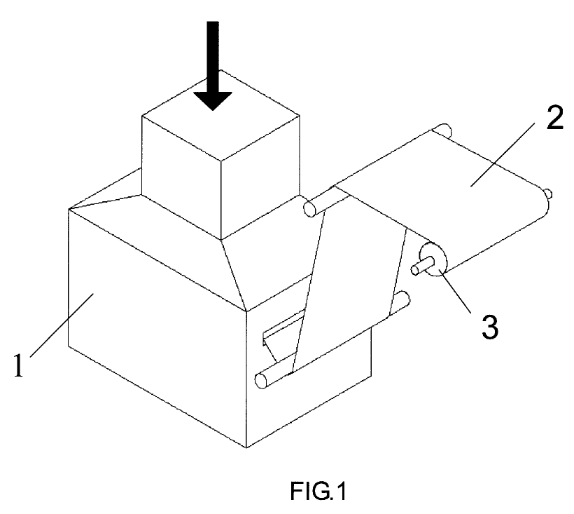

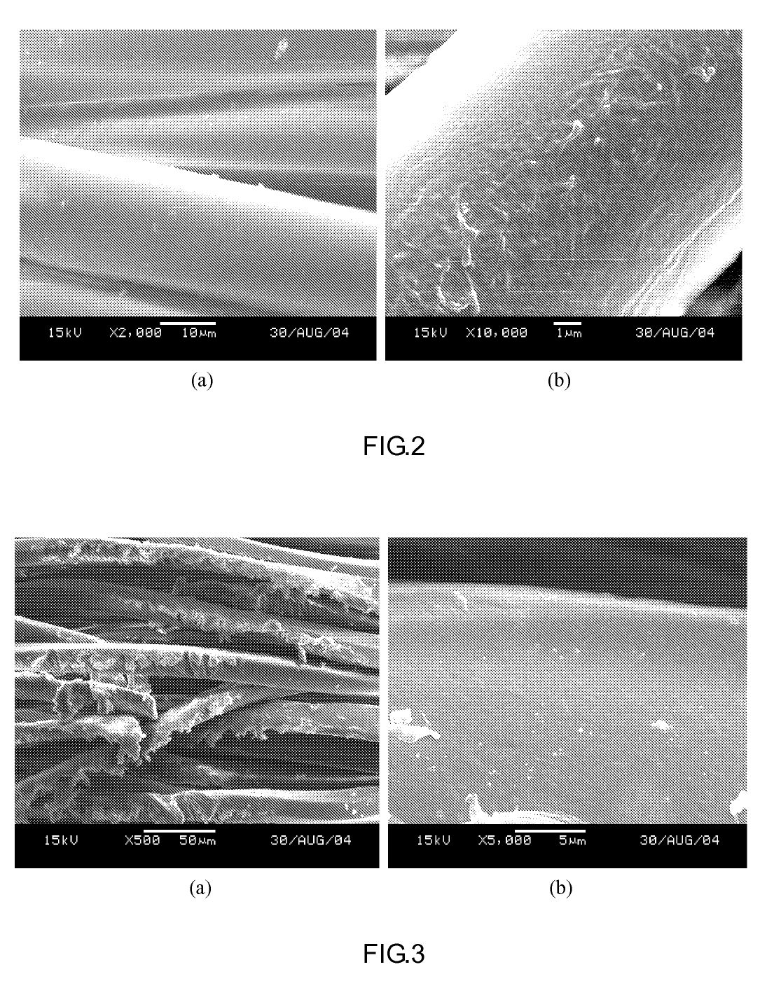

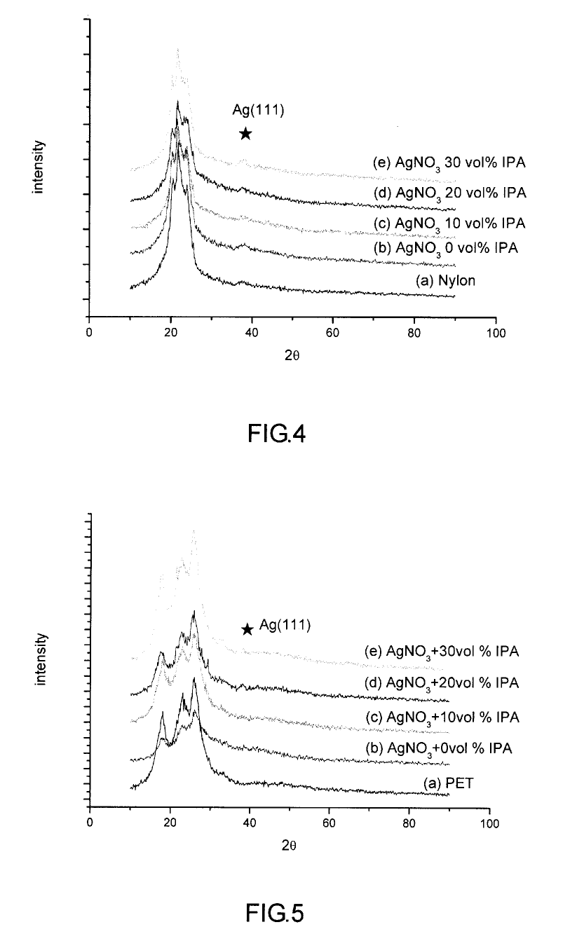

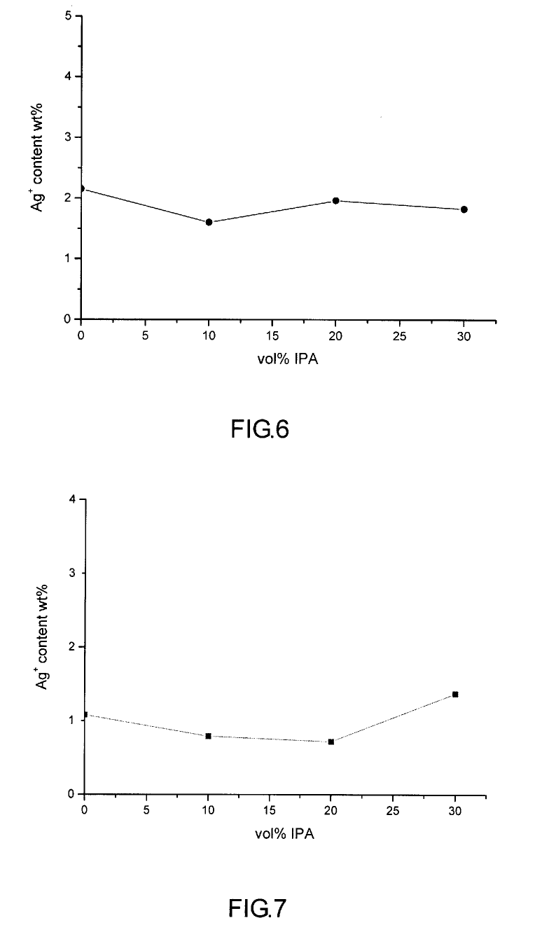

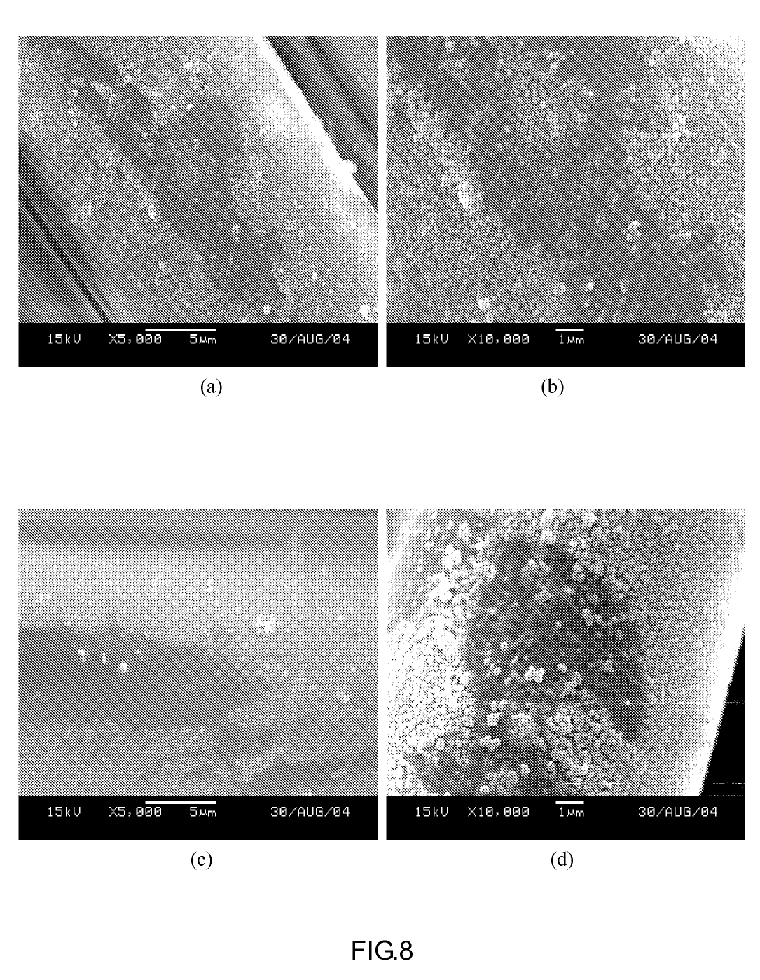

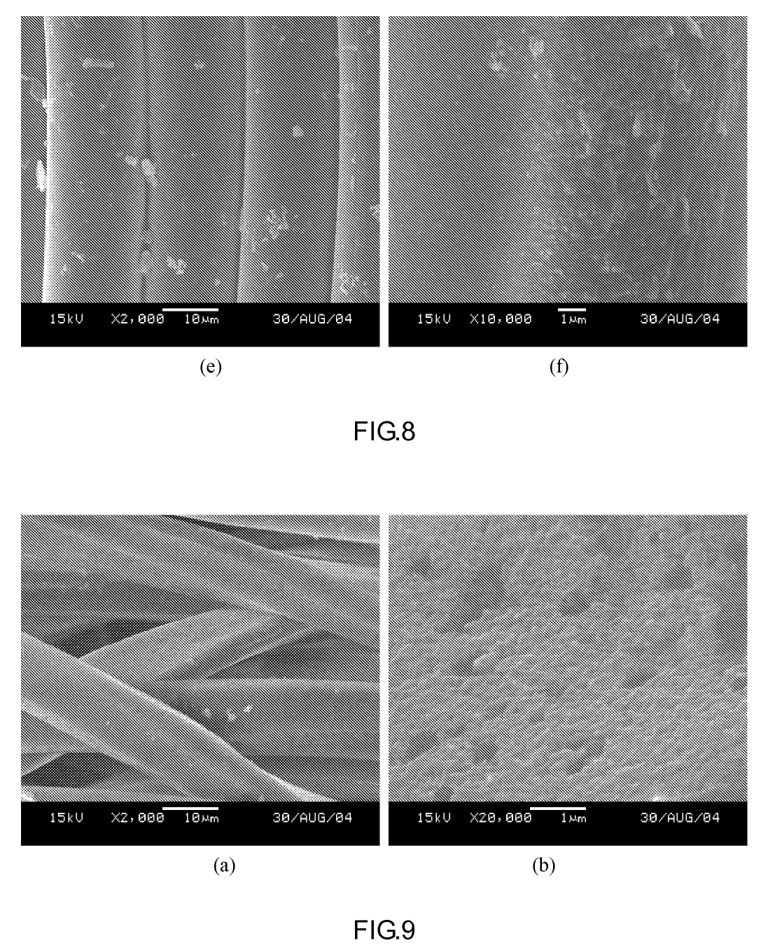

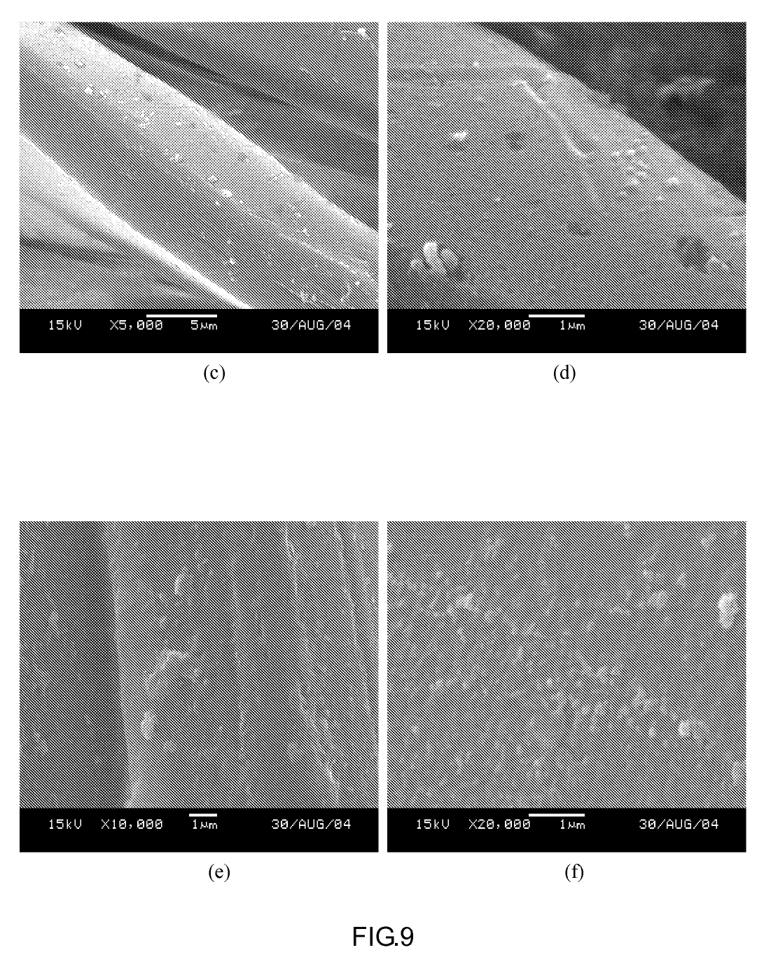

What is claimed is:

1. A preparation method for antibacterial nanocomposite fiber materials containing organic intermediates or free-radical scavengers and using nano silver antibacterial agents as the main reactant that is fixed onto Nylon or PET fiber surface by radiation modification consists of the following steps:
(a) cut Nylon and PET fiber substrate in a suitable size (≧10 cm×10 cm);
(b) mix and agitate evenly the mixture of silver nitrate solution and PAA or IPA solution; impregnate Nylon and PET fiber materials into the solution for more than two hours;
(c) the above fiber materials are subject to pressing and sucking by a nip roll for more than 2.0 kg/cm² pressure to remove the extra mixture solution from the above;
(d) put Nylon and PET fiber semi-products to a sealed plastic bag and irradiate them for modification.

2. As described in claim 1 for a preparation method for antibacterial nanocomposite fiber materials containing organic intermediates or free-radical scavengers, the impregnation solution for Nylon and PET fibers have more than 3.5 g PAA (organic intermediate) and higher than 0.1M AgNO₃.

3. As described in claim 1 for a preparation method for antibacterial nanocomposite fiber materials containing organic intermediates or free-radical scavengers, the modification is conducted by radiation of dosage preferably less than 80 kGy.

4. As described in claim 1 for a preparation method for antibacterial nanocomposite fiber materials containing organic intermediates or free-radical scavengers, for Nylon fibers, adding organic intermediate PAA decreases silver content from 2.15 wt % to 0.83 wt %. For PET fibers, adding PAA can increase silver content from 1.08 wt % to 3.04 wt %.
